(19) United States
(12) Patent Application Publication
(10) Pub. No.: US 2025/0262827 A1
(43) Pub. Date: Aug. 21, 2025

(54) COMPOSITE REPAIR

(71) Applicant: The Boeing Company, Arlington, VA (US)

(72) Inventors: Alexander Michael Rubin, St. Louis, MO (US); Michael H. Larson, Mercer Island, WA (US); Gwendolyn Marie Janda, Seattle, WA (US); Scott William Gunther, Bothell, WA (US); Ying Shi, St. Louis, MO (US)

(21) Appl. No.: 18/444,466

(22) Filed: Feb. 16, 2024

(51) Int. Cl. B29C 73/10; B29C 73/26; B29C 73/34; B29L 31/30

(52) U.S. Cl. CPC B29C 73/10; B29C 73/34; B29C 2073/262; B29C 2793/0027; B29L 2031/3076

(57) ABSTRACT

Methods for repairing thermoplastic composite parts are presented. A heating element impregnated with a thermoplastic material is placed onto a repair area of a thermoplastic composite part. The thermoplastic material of the heating element is adhered to the repair area by generating heat in the heating element from current applied to the heating element. A repair patch is placed over the heating element after adhering the heating element to the repair area. A current is applied to the heating element to heat the repair patch to a patch processing temperature.

### BACKGROUND INFORMATION

### 1. Field

The present disclosure relates generally to composite repair and more specifically to repairing thermoplastic composite parts with a heating element comprising a thermoplastic material.

### 2. Background

Currently repair techniques for thermoplastic composite parts are under design and research. Some thermoset patches can be applied using adhesive to bond the thermoset patches onto thermoplastic parts. A heating blanket can be used to cure the thermoset patch. Current thermoset adhesion methods use an energetic surface preparation method such as plasma treatment on the thermoplastic part. Energetic surface treatments have a time limit for usability. Additionally, the energetic surface preparation methods have to be able to reach the areas to service the thermoplastic composite part. On some portions of vehicles and other platforms, access can be difficult. Joining a thermoset patch to a thermoplastic part can be undesirably time consuming and difficult to scale to large acreage parts.

Therefore, it would be desirable to have a method and apparatus that takes into account at least some of the issues discussed above, as well as other possible issues. It would be desirable to have thermoplastic repair methods that use at least one of less time or less energy.

### SUMMARY

An embodiment of the present disclosure provides a method of repairing a thermoplastic composite part. A heating element impregnated with a thermoplastic material is placed onto a repair area of a thermoplastic composite part. The thermoplastic material of the heating element is adhered to the repair area by generating heat in the heating element from current applied to the heating element. A repair patch is placed over the heating element after adhering the heating element to the repair area. A current is applied to the heating element to heat the repair patch to a patch processing temperature.

Another embodiment of the present disclosure provides a method of repairing a thermoplastic composite part. A heating element impregnated with a thermoplastic material is placed onto a repair area of a thermoplastic composite part. The thermoplastic material of the heating element is adhered to the repair area by generating heat in the heating element from current applied to the heating element. A thermoplastic repair patch is placed over the heating element after adhering the heating element to the repair area. The thermoplastic repair patch is heated to a patch processing temperature using the heating element. Pressure is applied to the thermoplastic repair patch while heating the repair patch.

Yet another embodiment of the present disclosure provides a method of repairing a thermoplastic composite part. A heating element impregnated with a thermoplastic material is placed onto a repair area of a thermoplastic composite part. The thermoplastic material of the heating element is adhered to the repair area by generating heat in the heating element from current applied to the heating element. A thermoset repair patch is placed over the heating element after adhering the heating element to the repair area. The thermoset repair patch is heated to a patch processing temperature using a heating element. Pressure is applied to the repair patch while heating the thermoset repair patch.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is a cross-sectional view of a repair of a thermoplastic composite part in accordance with an illustrative embodiment;

FIG. 4 is a cross-sectional view of a repair of a thermoplastic composite part in accordance with an illustrative embodiment;

FIG. 5 is a cross-sectional view of a repair of a thermoplastic composite part in accordance with an illustrative embodiment;

FIG. 6 is a cross-sectional view of a repair of a thermoplastic composite part in accordance with an illustrative embodiment;

FIGS. 7A and 7B are a flowchart of a method of repairing a thermoplastic composite part in accordance with an illustrative embodiment;

FIG. 8 is a flowchart of a method of repairing a thermoplastic composite part in accordance with an illustrative embodiment;

FIG. 9 is a flowchart of a method of repairing a thermoplastic composite part in accordance with an illustrative embodiment;

FIG. 10 is a flowchart of a method of repairing a thermoplastic composite part in accordance with an illustrative embodiment;

FIG. 11 is an illustration of an aircraft manufacturing and service method in a form of a block diagram in accordance with an illustrative embodiment; and

FIG. 12 is an illustration of an aircraft in a form of a block diagram in which an illustrative embodiment may be implemented.

### DETAILED DESCRIPTION

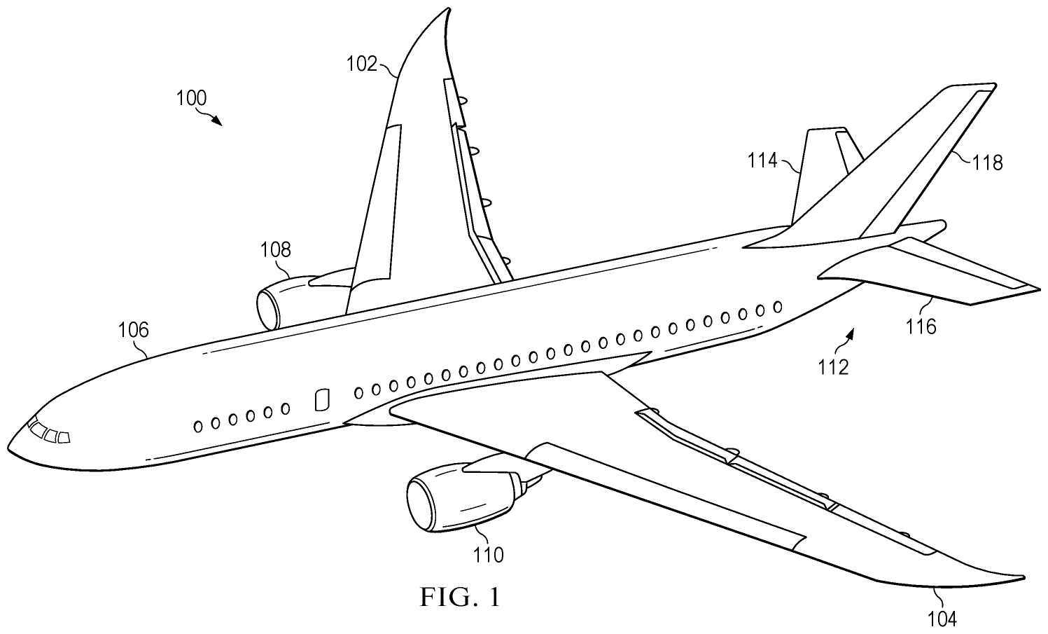

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have thermoplastic composite parts to be repaired. Thermoplastic composite parts of aircraft 100 in at least one of wing 102, wing 104, body 106, horizontal stabilizer 114, horizontal stabilizer 116, or vertical stabilizer 118 can be repaired using the illustrative examples.

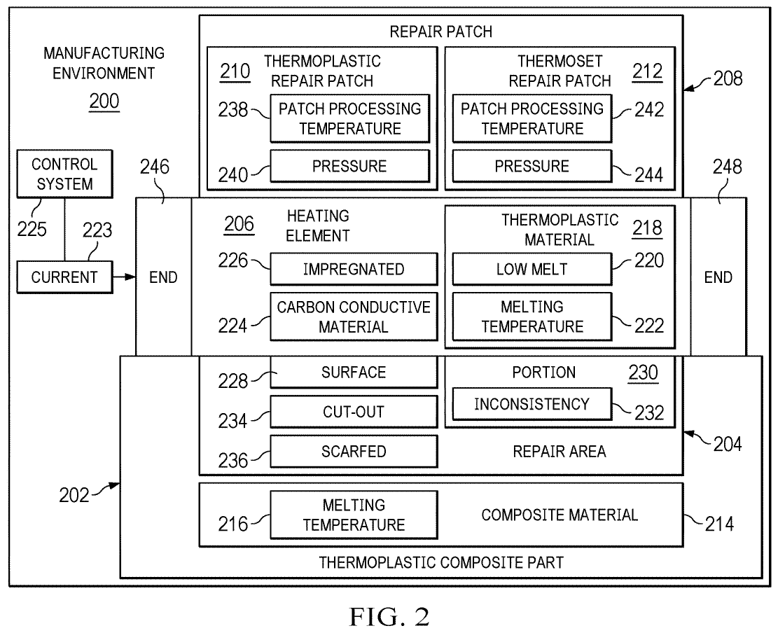

Turning now to FIG. 2, an illustration of a block diagram of a manufacturing environment is depicted in accordance with an illustrative embodiment. Manufacturing environment 200 is an environment in which repair of thermoplastic composite part 202 can be repaired. In this illustrative example, heating element 206 is applied to repair area 204 to adhere repair patch 208 onto thermoplastic composite part 202. Repair patch 208 can comprise either thermoplastic repair patch 210 or thermoset repair patch 212.

Thermoplastic composite part 202 comprises composite material 214 with melting temperature 216. Heating element 206 is impregnated 226 with thermoplastic material 218. Thermoplastic material 218 can be referred to as low melt 220 thermoplastic material 218. Thermoplastic material 218 can be referred to as being low melt 220 thermoplastic material 218 due to melting temperature 222 of thermoplastic material 218 being lower than melting temperature 216 of thermoplastic composite part 202. Heating element 206 can heat from room temperature to a desired joining temperature at a very fast rate (˜150° C./min).

Carbon conductive material 224 is present in heating element 206 to melt thermoplastic material 218 to adhere heating element 206 to thermoplastic composite part 202. Carbon conductive material 224 generates heat when current 223 is applied to carbon conductive material 224. In some illustrative examples, carbon conductive material 224 is one of a fiber, a mesh, a coil, or a unidirectional tape. In some illustrative examples, carbon conductive material 224 generates heat to melt thermoplastic material 218. In some illustrative examples, carbon conductive material 224 has a thickness in a range of 0.005″ to 0.02″. Carbon conductive material 224 produces heat when current 223 is applied to carbon conductive material 224.

Control system 225 is present to control application of current 223. In some illustrative examples, current 223 is controlled based on a feedback control loop. A temperature sensor can be present to monitor the temperature of heating element 206. Control system 225 is configured to control current 223 applied to carbon conductive material 224 based on the temperature of at least one of thermoplastic composite part 202, heating element 206, or repair patch 208.

Thermoplastic material 218 can take any desirable form with melting temperature 222 less than melting temperature 216 of thermoplastic composite part 202.

In some illustrative examples, thermoplastic material 218 is a polyaryletherketone. In some illustrative examples, polyaryletherketone has melting temperature 222 in a range of 260-350 degrees Celsius. In some illustrative examples, thermoplastic material 218 is a polyether ketone ketone. In some illustrative examples, thermoplastic material 218 is a polyether ether ketone. In some illustrative examples, thermoplastic material 218 is a mixture of two thermoplastic materials.

In some illustrative examples, a mixture of two thermoplastic materials has melting temperature 222 in range of 260-350 degrees Celsius and a glass transition temperature in a range of 180-200 degrees Celsius. The glass transition temperature can be used to join heating element 206 to thermoset materials, such as when repair patch 208 takes the form of thermoset repair patch 212. In some illustrative examples, thermoplastic material 218 is a mixture when repair patch 208 takes the form of thermoset repair patch 212.

In some illustrative examples, thermoplastic material 218 that will join thermoset repair patch 212 and thermoplastic composite part 202, is a mixture of two thermoplastic materials. In some illustrative examples, thermoplastic material 218 that will join two thermoplastic composite components, such as thermoplastic composite part 202 and thermoplastic repair patch 210 is a single thermoplastic material with melting temperature 222.

Heating element 206 impregnated 226 with thermoplastic material 218 is applied onto repair area 204 of thermoplastic composite part 202. Repair area 204 can take any desirable form. In some illustrative examples, repair area 204 is surface 228 over inconsistency 232. In these illustrative examples, inconsistency 232 can be left in thermoplastic composite part 202.

In some illustrative examples, the repair area is created by removing an inconsistency from the thermoplastic composite part. In some illustrative examples, repair area 204 comprises surface 228 of thermoplastic composite part 202 in cut-out 234 formed by removing inconsistency 232 from thermoplastic composite part 202.

In some illustrative examples, repair area 204 comprises portion 230 of thermoplastic composite part 202 after inconsistency 232 has been removed from thermoplastic composite part 202. In some illustrative examples, a series of layers of composite material have been cut away from thermoplastic composite part 202 to create repair area 204.

Repair area 204 can have any desirable size or shape. In some illustrative examples, repair area 204 is scarfed 236.

Thermoplastic material 218 of heating element 206 is adhered to repair area 204 by generating heat in heating element 206 from current 223 applied to heating element 206. After adhering heating element 206 to repair area 204, repair patch 208 is placed over heating element 206. Current 223 is applied to heating element 206 to heat repair patch 208 to a patch processing temperature.

In some illustrative examples, thermoplastic repair patch 210 is already consolidated and is the same material as thermoplastic composite part 202. When repair patch takes the form of thermoplastic repair patch 210, current 223 is applied to heating element 206 to heat thermoplastic repair patch 210 to patch processing temperature 238. Patch processing temperature 238 is selected to consolidate thermoplastic repair patch 210. In some illustrative examples, patch processing temperature 238 is approximately 280° C.-340° C. In some illustrative examples, patch processing temperature 238 is approximately 310° C.

During heating of thermoplastic repair patch 210, pressure 240 is applied to thermoplastic repair patch 210 to compress thermoplastic repair patch 210. In some illustrative examples, pressure 240 of approximately 15-45 psi is applied to thermoplastic repair patch 210 while heating thermoplastic repair patch 210 to join thermoplastic repair patch 210 to thermoplastic composite part 202. In some illustrative examples, pressure 240 of approximately 30 psi is applied to thermoplastic repair patch 210 while heating thermoplastic repair patch 210 to join thermoplastic repair patch 210 to thermoplastic composite part 202. In some illustrative examples, pressure 240 is removed from thermoplastic repair patch 210 after allowing thermoplastic repair patch 210 to cool to 150° C. When repair patch takes the form of thermoset repair patch 212, current 223 is applied to heating element 206 to heat thermoset repair patch 212 to patch processing temperature 242. Patch processing temperature 242 is selected to cure thermoset repair patch 212. In some illustrative examples, patch processing temperature 242 is approximately 170° C.-190° C. In some illustrative examples, patch processing temperature 242 is approximately 180° C.

During heating of thermoset repair patch 212, pressure 244 is applied to thermoset repair patch 212 to compress thermoset repair patch 212. In some illustrative examples, pressure 244 of approximately 60 psi-90 psi is applied to thermoset repair patch 212 while heating thermoset repair patch 212 to join thermoset repair patch 212 to thermoplastic composite part 202. In some illustrative examples, pressure 244 of approximately 85 psi is applied to thermoset repair patch 212 while heating thermoset repair patch 212 to join thermoset repair patch 212 to thermoplastic composite part 202. In some illustrative examples, pressure 244 is removed from thermoset repair patch 212 after allowing thermoset repair patch 212 to cool to ambient temperature.

In some illustrative examples, after adhering repair patch 208 to thermoplastic composite part 202, ends of heating element 206 can extend outside of repair patch 208. In some illustrative examples, after adhering repair patch 208 to thermoplastic composite part 202, ends of heating element 206 extending from thermoplastic composite part 202. As depicted, end 246 and end 248 of heating element 206 extend out from between repair patch 208 and thermoplastic composite part 202. As depicted, trimming ends of heating element 206 can comprise trimming end 246 and end 248.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, an additional heating element and an additional repair patch can be present. In some illustrative examples, a respective heating element and a respective repair patch is present on either side of inconsistency 232 of thermoplastic composite part 202 through the thickness.

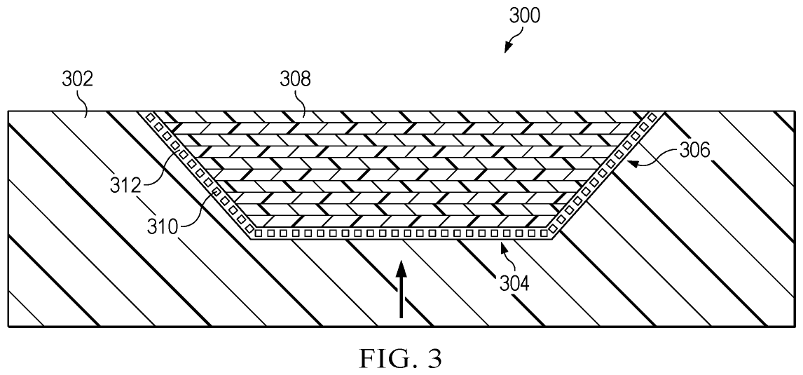

Turning now to FIG. 3, a cross-sectional view of a repair of a thermoplastic composite part is depicted in accordance with an illustrative embodiment. Thermoplastic composite part 302 is a physical implementation of thermoplastic composite part 202 of FIG. 2. In view 300, heating element 306 has been placed onto repair area 304 of thermoplastic composite part 302. In this illustrative example, repair area 304 comprises a portion of composite part 302 after an inconsistency has been removed from thermoplastic composite part 302. In this illustrative example, a series of layers of composite material have been cut away from thermoplastic composite part 302 to create repair area 304.

In this illustrative example, heating element 306 has been placed onto repair area 304 and heated to adhere heating element 306 to thermoplastic composite part 302. After adhering heating element 306 to thermoplastic composite part 302, repair patch 308 is placed over heating element 306. Heating element 306 is used to heat repair patch 308 to a patch processing temperature. The patch processing temperature is selected based on a material type of repair patch 308.

Repair patch 308 was previously laid up to approximate the layers of thermoplastic composite part 302 removed to create repair area 304. In some illustrative examples, repair patch 308 can be referred to as a scarf patch. When repair patch 308 is placed in contact with thermoplastic material 312 of heating element 306, repair patch 308 is in a consolidated state.

Heating element 306 is impregnated with thermoplastic material 312. Heating element 306 comprises carbon conductive material 310 and thermoplastic material 312. Thermoplastic material 312 is the portion of heating element 306 adhered to repair area 304 of thermoplastic composite part 302. Carbon conductive material 310 is a portion of heating element 306 that generates heat in response to running a current into heating element 306.

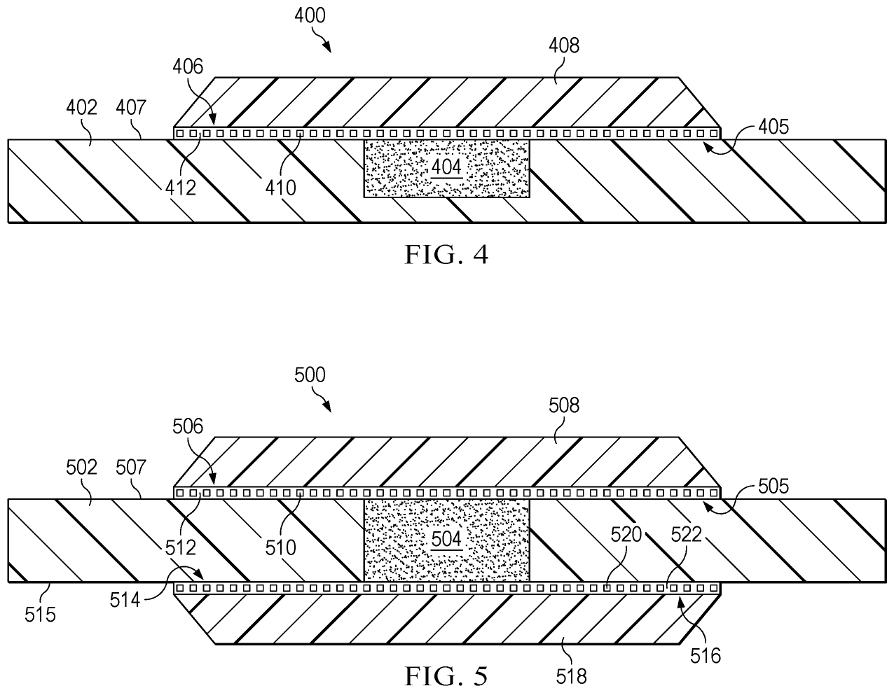

Turning now to FIG. 4, a cross-sectional view of a repair of a thermoplastic composite part is depicted in accordance with an illustrative embodiment. Thermoplastic composite part 402 is a physical implementation of thermoplastic composite part 202 of FIG. 2. In view 400, heating element 406 has been placed onto repair area 405 of thermoplastic composite part 402. In this illustrative example, repair area 405 comprises a portion of surface 407 of composite part 402. In this illustrative example, inconsistency 404 is present in thermoplastic composite part 402. Repair area 405 is a portion of surface 407 over inconsistency 404 in thermoplastic composite part 402.

In this illustrative example, heating element 406 has been placed onto repair area 405 and heated to adhere heating element 406 to repair area 405 of thermoplastic composite part 402. After adhering heating element 406 to thermoplastic composite part 402, repair patch 408 is placed over heating element 406. Heating element 406 is used to heat repair patch 408 to a patch processing temperature. The patch processing temperature is selected based on a material type of repair patch 408.

Repair patch 408 is laid up over inconsistency 404 without removing inconsistency 404 from thermoplastic composite part 402. In some illustrative examples, repair patch 408 can be referred to as an external doubler. Repair patch 408 can be used for repair of inconsistencies that do not extend through the thickness of thermoplastic composite part 402.

Heating element 406 is impregnated with thermoplastic material 412. Heating element 406 comprises carbon conductive material 410 and thermoplastic material 412. Thermoplastic material 412 is the portion of heating element 406 adhered to thermoplastic composite part 402. Carbon conductive material 410 is a portion of heating element 406 that generates heat in response to running a current into heating element 406.

Turning now to FIG. 5, a cross-sectional view of a repair of a thermoplastic composite part is depicted in accordance with an illustrative embodiment. Thermoplastic composite part 502 is a physical implementation of thermoplastic composite part 202 of FIG. 2. In view 500, heating element 506 has been placed onto repair area 505 of thermoplastic composite part 502. In view 500, heating element 516 has been placed onto repair area 514 of thermoplastic composite part 502. In this illustrative example, repair area 505 and repair area 514 are on surfaces of composite part 502. In this illustrative example, repair area 505 comprises a portion of surface 507 of composite part 502. In this illustrative example, inconsistency 504 is present in thermoplastic composite part 502. Repair area 505 is a portion of surface 507 over inconsistency 504 in thermoplastic composite part 502.

In this illustrative example, repair area 514 comprises a portion of surface 515 of composite part 502. In this illustrative example, repair area 514 is a portion of surface 515 over inconsistency 504 in thermoplastic composite part 502.

In this illustrative example, heating element 506 has been placed onto repair area 505 and heated to adhere heating element 506 to repair area 505 of thermoplastic composite part 502. After adhering heating element 506 to thermoplastic composite part 502, repair patch 508 is placed over heating element 506. Heating element 506 is used to heat repair patch 508 to a patch processing temperature. The patch processing temperature is selected based on a material type of repair patch 508.

Heating element 506 is impregnated with thermoplastic material 512. Heating element 506 comprises carbon conductive material 510 and thermoplastic material 512. Thermoplastic material 512 is the portion of heating element 506 adhered to thermoplastic composite part 502. Carbon conductive material 510 is a portion of heating element 506 that generates heat in response to running a current into heating element 506.

In this illustrative example, heating element 516 has been placed onto repair area 514 and heated to adhere heating element 516 to repair area 514 of thermoplastic composite part 502. After adhering heating element 516 to thermoplastic composite part 502, repair patch 518 is placed over heating element 516. Heating element 516 is used to heat repair patch 518 to a patch processing temperature. The patch processing temperature is selected based on a material type of repair patch 518.

Heating element 516 is impregnated with thermoplastic material 522. Heating element 516 comprises carbon conductive material 520 and thermoplastic material 522. Thermoplastic material 522 is the portion of heating element 516 adhered to thermoplastic composite part 502. Carbon conductive material 520 is a portion of heating element 516 that generates heat in response to running a current into heating element 516.

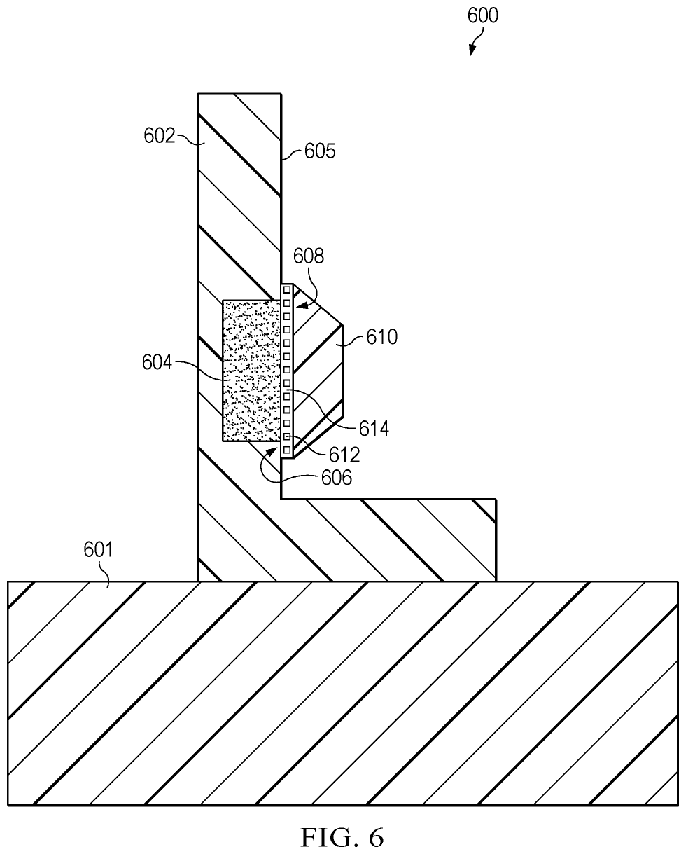

Turning now to FIG. 6, a cross-sectional view of a repair of a thermoplastic composite part is depicted in accordance with an illustrative embodiment. Thermoplastic composite part 602 is a physical implementation of thermoplastic composite part 202 of FIG. 2. In view 600, heating element 608 has been placed onto repair area 606 of thermoplastic composite part 602. In this illustrative example, thermoplastic composite part 602 is a stiffener. Thermoplastic composite part 602 is a stiffener joined to thermoplastic composite skin 601.

In this illustrative example, repair area 606 comprises a portion of surface 605 of composite part 602. In this illustrative example, inconsistency 604 is present in thermoplastic composite part 602. Repair area 606 is a portion of surface 605 over inconsistency 604 in thermoplastic composite part 602.

In this illustrative example, heating element 608 has been placed onto repair area 606 and heated to adhere heating element 608 to repair area 606 of thermoplastic composite part 602. After adhering heating element 608 to thermoplastic composite part 602, repair patch 610 is placed over heating element 608. Heating element 608 is used to heat repair patch 610 to a patch processing temperature. The patch processing temperature is selected based on a material type of repair patch 610.

Repair patch 610 is laid up over inconsistency 604 without removing inconsistency 604 from thermoplastic composite part 602. In some illustrative examples, repair patch 610 can be referred to as an external doubler. Repair patch 610 can be used for repair of inconsistencies that do not extend through the thickness of thermoplastic composite part 602.

Heating element 608 is impregnated with thermoplastic material 614. Heating element 608 comprises carbon conductive material 612 and thermoplastic material 614. Thermoplastic material 614 is the portion of heating element 608 adhered to thermoplastic composite part 602. Carbon conductive material 612 is a portion of heating element 608 that generates heat in response to running a current into heating element 608.

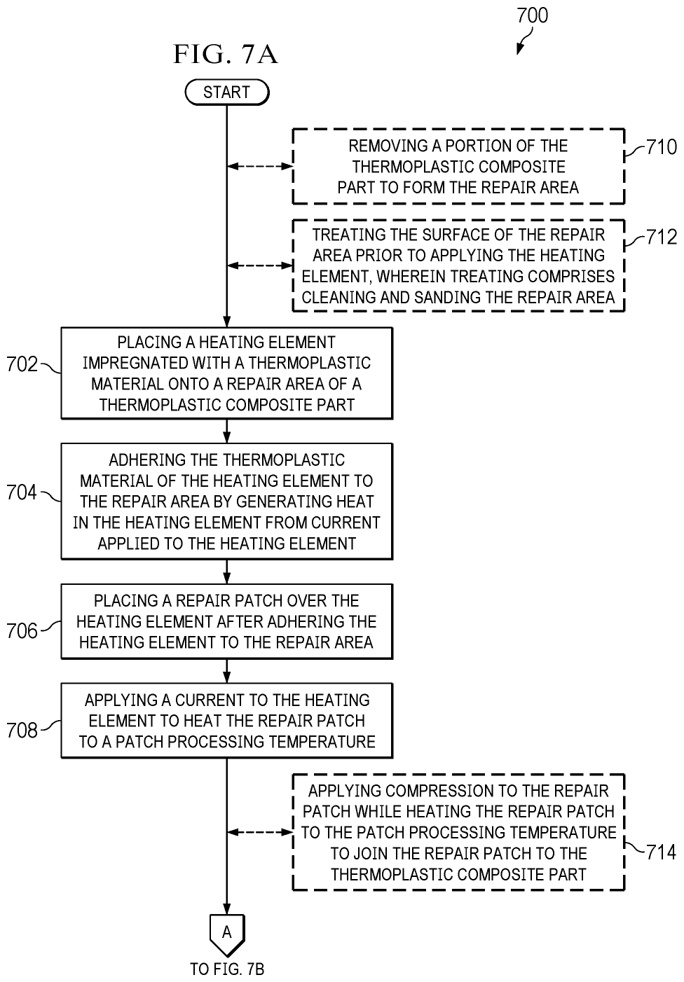

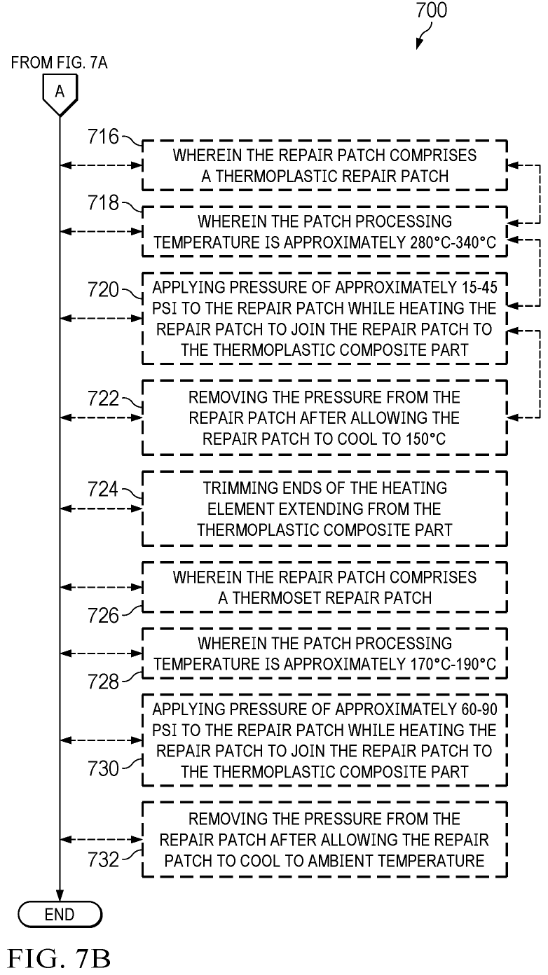

Turning now to FIGS. 7A and 7B, a flowchart of a method of repairing a thermoplastic composite part is depicted in accordance with an illustrative embodiment. Method 700 can be performed to repair a thermoplastic composite part of aircraft 100 of FIG. 1. Method 700 can be performed to repair thermoplastic composite part 202 of FIG. 2. Method 700 can be performed to repair thermoplastic composite part 302 of FIG. 3. Method 700 can be performed to repair thermoplastic composite part 402 of FIG. 4. Method 700 can be performed to repair thermoplastic composite part 502 of FIG. 5. Method 700 can be performed to repair thermoplastic composite part 602 of FIG. 6.

Method 700 places a heating element impregnated with a thermoplastic material onto a repair area of a thermoplastic composite part (operation 702). The repair area can take any desirable form. In some illustrative examples, the repair area is a surface over an inconsistency. In some illustrative examples, the repair area is created by removing an inconsistency from the thermoplastic composite part. The repair area can have any desirable size or shape.

Method 700 adheres the thermoplastic material of the heating element to the repair area by generating heat in the heating element from current applied to the heating element (operation 704). Method 700 places a repair patch over the heating element after adhering the heating element to the repair area (operation 706). Method 700 applies a current to the heating element to heat the repair patch to a patch processing temperature (operation 708). Afterwards, method 700 terminates.

In some illustrative examples, method 700 removes a portion of the thermoplastic composite part to form the repair area (operation 710). In some illustrative examples, the portion of the thermoplastic composite part removed comprises an inconsistency. In some illustrative examples, removing the portion of the thermoplastic composite part comprises iteratively removing layers of the thermoplastic composite part. In some illustrative examples, removing the portion of the thermoplastic composite part comprises removing a scarfed section from the thermoplastic composite part.

In some illustrative examples, method 700 treats the surface of the repair area prior to applying the heating element, wherein treating comprises cleaning and sanding the repair area (operation 712). In these illustrative examples, treating the surface comprises treating the surface without the use of high energy preparations. In these illustrative examples, treating the surface comprises treating the surface without plasma treatment.

In some illustrative examples, method 700 applies compression to the repair patch while heating the repair patch to the patch processing temperature to join the repair patch to the thermoplastic composite part (operation 714). The compression is sufficient to process the material of the repair patch during heating.

In some illustrative examples, the repair patch comprises a thermoplastic repair patch (operation 716). In some illustrative examples, the patch processing temperature is approximately 280° C.-340° C. (operation 718). In some illustrative examples, the patch processing temperature is approximately 310° C. In some illustrative examples, method 700 applies pressure of approximately 15-45 psi to the repair patch while heating the repair patch to join the repair patch to the thermoplastic composite part (operation 720). In some illustrative examples, method 700 applies pressure of approximately 30 psi to the repair patch while heating the repair patch to join the repair patch to the thermoplastic composite part. In some illustrative examples, method 700 removes the pressure from the repair patch after allowing the repair patch to cool to 150° C. (operation 722).

In some illustrative examples, method 700 trims ends of the heating element extending from the thermoplastic composite part (operation 724). In some illustrative examples, the ends of the heating element extending past the repair patch are trimmed. In some illustrative examples, the ends trimmed are exposed.

In some illustrative examples, the repair patch comprises a thermoset repair patch (operation 726). In some illustrative examples, the patch processing temperature is approximately 170° C.-190° C. (operation 728). In some illustrative examples, the patch processing temperature is approximately 180° C. In some illustrative examples, method 700 applies pressure of approximately 60-90 psi to the repair patch while heating the repair patch to join the repair patch to the thermoplastic composite part (operation 730). In some illustrative examples, method 700 applies pressure of approximately 85 psi to the repair patch while heating the repair patch to join the repair patch to the thermoplastic composite part. In some illustrative examples, method 700 removes the pressure from the repair patch after allowing the repair patch to cool to ambient temperature (operation 732).

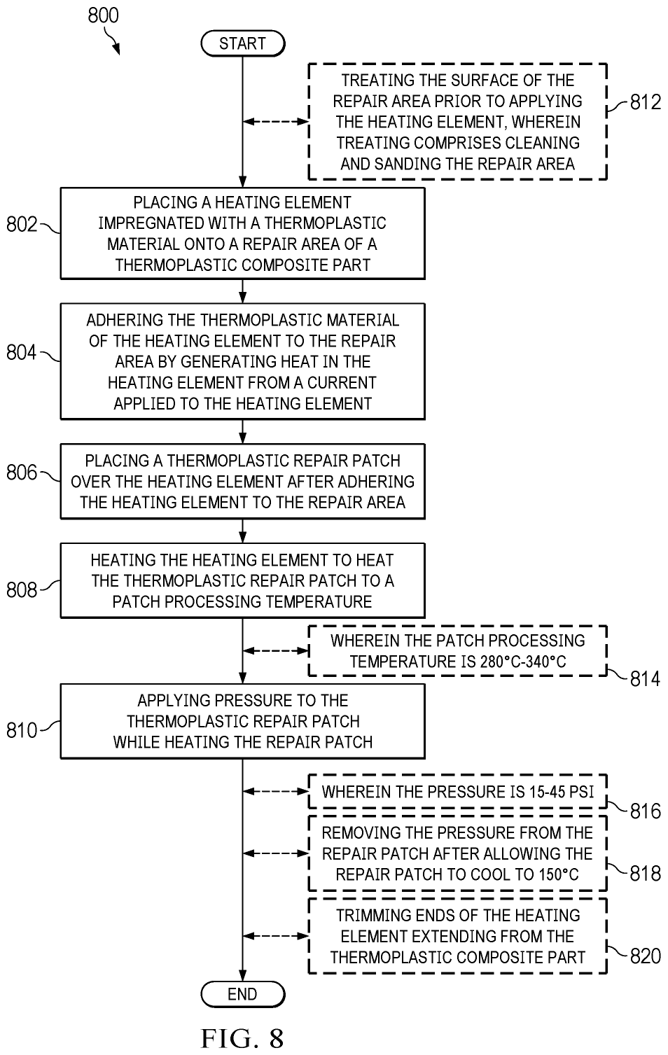

Turning now to FIG. 8, a flowchart of a method of repairing a thermoplastic composite part is depicted in accordance with an illustrative embodiment. Method 800 can be performed to repair a thermoplastic composite part of aircraft 100 of FIG. 1. Method 800 can be performed to repair thermoplastic composite part 202 of FIG. 2. Method 800 can be performed to repair thermoplastic composite part 302 of FIG. 3. Method 800 can be performed to repair thermoplastic composite part 402 of FIG. 4. Method 800 can be performed to repair thermoplastic composite part 502 of FIG. 5. Method 800 can be performed to repair thermoplastic composite part 602 of FIG. 6.

Method 800 places a heating element impregnated with a thermoplastic material onto a repair area of a thermoplastic composite part (operation 802). Method 800 adheres the thermoplastic material of the heating element to the repair area by generating heat in the heating element from current applied to the heating element (operation 804). Method 800 places a thermoplastic repair patch over the heating element after adhering the heating element to the repair area (operation 806). Method 800 heats the thermoplastic repair patch to a patch processing temperature using a heating element (operation 808). Method 800 applies pressure to the thermoplastic repair patch while heating the repair patch (operation 810). Afterwards, method 800 terminates.

In some illustrative examples, method 800 treats the surface of the repair area prior to applying the heating element, wherein treating comprises cleaning and sanding the repair area (operation 812). In these illustrative examples, treating the surface comprises treating the surface without the use of high energy preparations. In these illustrative examples, treating the surface comprises treating the surface without plasma treatment.

In some illustrative examples, the patch processing temperature is 280° C.-340° C. (operation 814). In some illustrative examples, the patch processing temperature is approximately 310° C. In some illustrative examples, the pressure is 15-45 psi (operation 816). In some illustrative examples, the pressure is approximately 30 psi. In some illustrative examples, method 800 removes the pressure from the repair patch after allowing the repair patch to cool to 150° C. (operation 818).

In some illustrative examples, method 800 trims ends of the heating element extending from the thermoplastic composite part (operation 820). The heating element remains in the thermoplastic composite part after applying the repair patch. The heating element remains in the thermoplastic composite part during operation of the platform, such as an aircraft, containing the thermoplastic composite part. In some illustrative examples, the ends of the heating element extending past the repair patch are trimmed. In some illustrative examples, the ends trimmed are exposed after adhering the repair patch to the thermoplastic composite part.

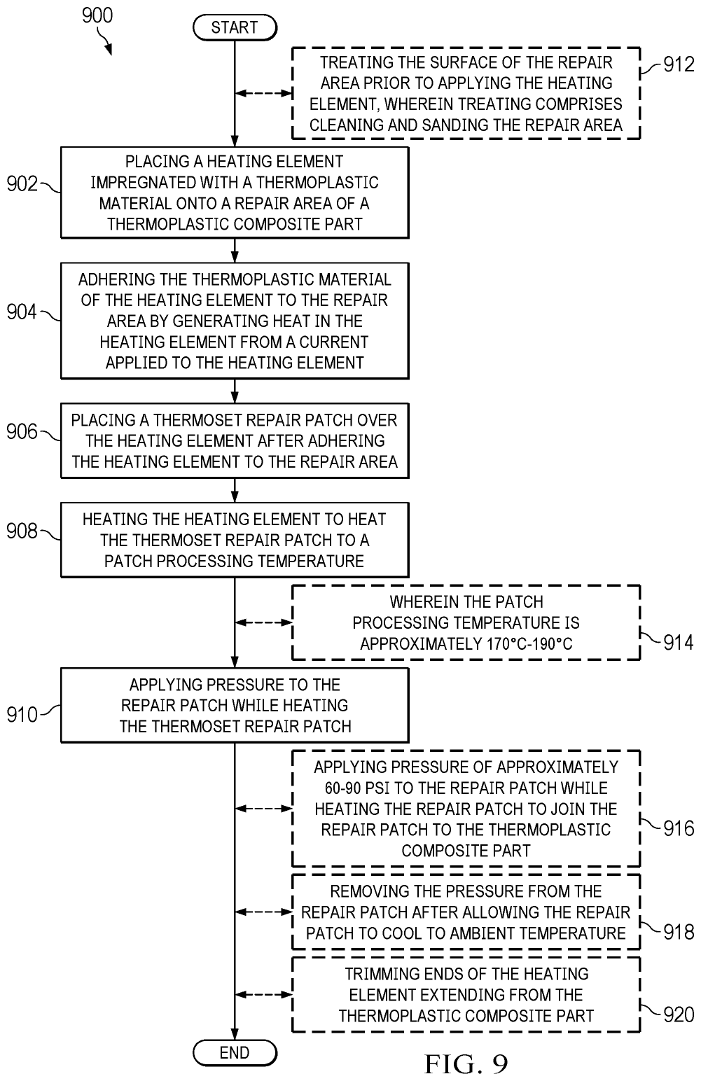

Turning now to FIG. 9, a flowchart of a method of repairing a thermoplastic composite part is depicted in accordance with an illustrative embodiment. Method 900 can be performed to repair a thermoplastic composite part of aircraft 100 of FIG. 1. Method 900 can be performed to repair thermoplastic composite part 202 of FIG. 2. Method 900 can be performed to repair thermoplastic composite part 302 of FIG. 3. Method 900 can be performed to repair thermoplastic composite part 402 of FIG. 4. Method 900 can be performed to repair thermoplastic composite part 502 of FIG. 5. Method 900 can be performed to repair thermoplastic composite part 602 of FIG. 6.

Method 900 places a heating element impregnated with a thermoplastic material onto a repair area of a thermoplastic composite part (operation 902). Method 900 adheres the thermoplastic material of the heating element to the repair area by generating heat in the heating element from a current applied to the heating element (operation 904). Method 900 places a thermoset repair patch over the heating element after adhering the heating element to the repair area (operation 906). Method 900 heats the thermoset repair patch to a patch processing temperature using a heating element (operation 908). Method 900 applies pressure to the repair patch while heating the thermoset repair patch (operation 910). Afterwards, method 900 terminates.

In some illustrative examples, method 900 treats the surface of the repair area prior to applying the heating element, wherein treating comprises cleaning and sanding the repair area (operation 912). In these illustrative examples, treating the surface comprises treating the surface without the use of high energy preparations. In these illustrative examples, treating the surface comprises treating the surface without plasma treatment.

In some illustrative examples, the patch processing temperature is approximately 170° C.-190° C. (operation 914). In some illustrative examples, the patch processing temperature is approximately 180° C. In some illustrative examples, method 900 applies pressure of approximately 60-90 psi to the repair patch while heating the repair patch to join the repair patch to the thermoplastic composite part (operation 916). In some illustrative examples, method 900 applies pressure of approximately 85 psi to the repair patch while heating the repair patch to join the repair patch to the thermoplastic composite part. In some illustrative examples, method 900 removes the pressure from the repair patch after allowing the repair patch to cool to ambient temperature (operation 918).

In some illustrative examples, method 900 trims ends of the heating element extending from the thermoplastic composite part (operation 920). The heating element remains in the thermoplastic composite part after applying the repair patch. The heating element remains in the thermoplastic composite part during operation of the platform, such as an aircraft, containing the thermoplastic composite part. In some illustrative examples, the ends of the heating element extending past the repair patch are trimmed. In some illustrative examples, the ends trimmed are exposed.

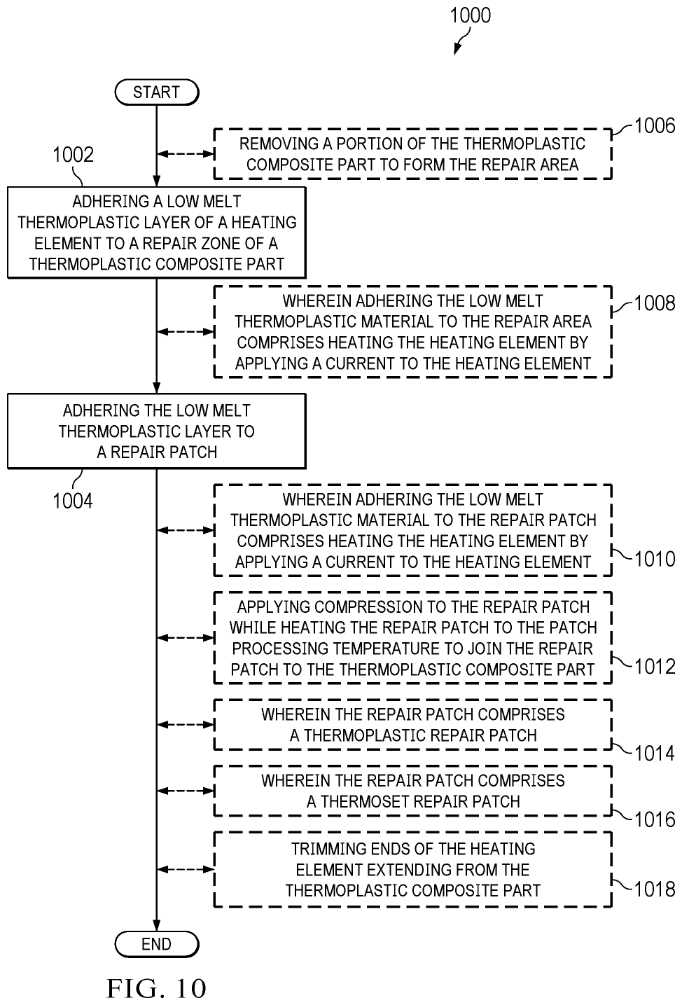

Turning now to FIG. 10, a flowchart of a method of repairing a thermoplastic composite part is depicted in accordance with an illustrative embodiment. Method 1000 can be performed to repair a thermoplastic composite part of aircraft 100 of FIG. 1. Method 1000 can be performed to repair thermoplastic composite part 202 of FIG. 2. Method 1000 can be performed to repair thermoplastic composite part 302 of FIG. 3. Method 1000 can be performed to repair thermoplastic composite part 402 of FIG. 4. Method 1000 can be performed to repair thermoplastic composite part 502 of FIG. 5. Method 1000 can be performed to repair thermoplastic composite part 602 of FIG. 6.

Method 1000 adheres a low melt thermoplastic material of a heating element to a repair area of a thermoplastic composite part (operation 1002). Method 1000 adheres the low melt thermoplastic material to a repair patch (operation 1004). Afterwards, method 1000 terminates.

In some illustrative examples, method 1000 removes a portion of the thermoplastic composite part to form the repair area (operation 1006). In some illustrative examples, the portion of the thermoplastic composite part removed comprises an inconsistency. In some illustrative examples, removing the portion of the thermoplastic composite part comprises iteratively removing layers of the thermoplastic composite part. In some illustrative examples, removing the portion of the thermoplastic composite part comprises removing a scarfed section from the thermoplastic composite part.

In some illustrative examples, adhering the low melt thermoplastic material to the repair area comprises heating the heating element by applying a current to the heating element (operation 1008). In some illustrative examples, the current applied to the heating element heats a carbon conductive material in the heating element. In some illustrative examples wherein adhering the low melt thermoplastic material to the repair patch comprises heating the heating element by applying a current to the heating element (operation 1010).

In some illustrative examples, method 1000 applies compression to the repair patch while heating the repair patch to the patch processing temperature to join the repair patch to the thermoplastic composite part (operation 1012). The amount of compression is selected based on a type of material for the repair patch.

In some illustrative examples, the repair patch comprises a thermoplastic repair patch (operation 1014). In some other illustrative examples, the repair patch comprises a thermoset repair patch (operation 1016). The thermoplastic material in the heating element would be different for a thermoplastic repair patch than the thermoplastic material in the heating element for a thermoset repair patch. Additionally, processing temperatures and pressures for the repair patch would differ for thermoplastic and thermoset repair patches.

In some illustrative examples, method 1000 trims ends of the heating element extending from the thermoplastic composite part (operation 1018). The heating element remains in the thermoplastic composite part after applying the repair patch. The heating element remains in the thermoplastic composite part during operation of the platform, such as an aircraft, containing the thermoplastic composite part. Any ends of the heating element extending out of the thermoplastic composite part are trimmed.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C, or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 710 through operation 732 may be optional. For example, operation 812 through operation 820 may be optional. For example, operation 912 through operation 920 may be optional.

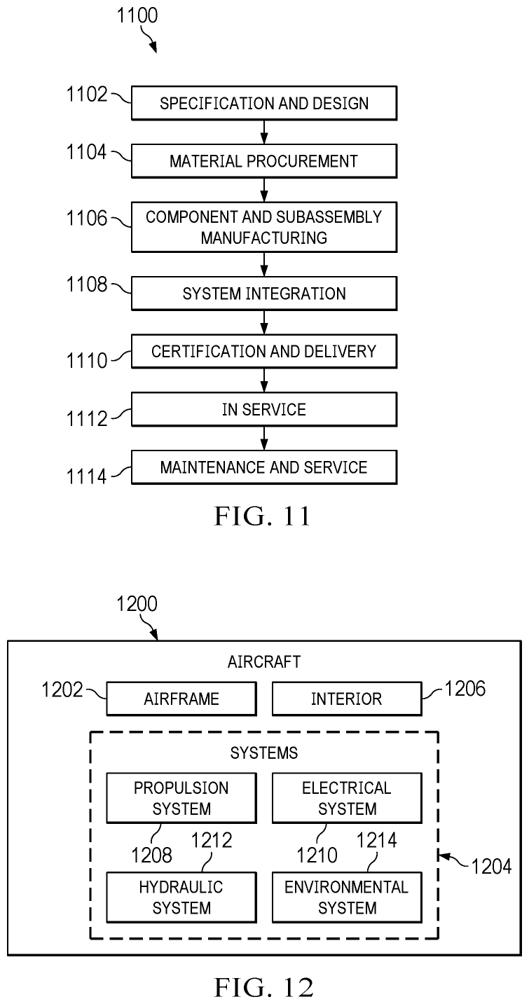

Illustrative embodiments of the present disclosure may be described in the context of aircraft manufacturing and service method 1100 as shown in FIG. 11 and aircraft 1200 as shown in FIG. 12. Turning first to FIG. 11, an illustration of an aircraft manufacturing and service method in a form of a block diagram is depicted in accordance with an illustrative embodiment. During pre-production, aircraft manufacturing and service method 1100 may include specification and design 1102 of aircraft 1200 in FIG. 12 and material procurement 1104.

During production, component and subassembly manufacturing 1106 and system integration 1108 of aircraft 1200 takes place. Thereafter, aircraft 1200 may go through certification and delivery 1110 in order to be placed in service 1112. While in service 1112 by a customer, aircraft 1200 is scheduled for routine maintenance and service 1114, which may include modification, reconfiguration, refurbishment, or other maintenance and service.

Each of the processes of aircraft manufacturing and service method 1100 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 12, an illustration of an aircraft in a form of a block diagram is depicted in which an illustrative embodiment may be implemented. In this example, aircraft 1200 is produced by aircraft manufacturing and service method 1100 of FIG. 11 and may include airframe 1202 with plurality of systems 1204 and interior 1206. Examples of systems 1204 include one or more of propulsion system 1208, electrical system 1210, hydraulic system 1212, and environmental system 1214. Any number of other systems may be included.

Apparatuses and methods embodied herein may be employed during at least one of the stages of aircraft manufacturing and service method 1100. One or more illustrative embodiments may be manufactured or used during at least one of component and subassembly manufacturing 1106, system integration 1108, in service 1112, or maintenance and service 1114 of FIG. 11.

The illustrative examples use heating elements comprising thermoplastic material to join a repair patch to a thermoplastic part with an inconsistency. The illustrative examples enable the use of either thermoplastic repair patches or thermoset repair patches without a surface preparation step of the thermoplastic part. A heating element in the joining line provides localized heating to the joining area. The heating element can heat from room temperature to a desired joining temperature at a very fast rate (˜150° C./min).

The illustrative examples provide methods of performing structural repair on thermoplastic parts during production and in service. The illustrative examples use low melting temperature thermoplastic materials in heating elements to join repair patches to the thermoplastic composite parts. The repair patch can be a thermoplastic composite patch or a thermoset composite patch. Depending on the material of repair patches, different thermoplastic films are used.

The illustrative examples eliminate the use of surface preparation other than cleaning or sanding for using a repair patch. The illustrative examples eliminate the use of surface preparation, including high-energy preparations such as plasma treatment, for using a repair patch. The illustrative examples eliminate the use of traditional structural adhesives in joining the repair patch to a thermoplastic composite part. The illustrative examples utilize a heating element in between the repair patch and the thermoplastic composite part to provide localized heating to join them. The use of the heating element increases efficiency and enables the repair for in service aircraft. Different thermoplastic formulations for the heating element enable repair with either a thermoplastic path or a thermoset patch.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A method of repairing a thermoplastic composite part comprising:
placing a heating element impregnated with a thermoplastic material onto a repair area of a thermoplastic composite part;
adhering the thermoplastic material of the heating element to the repair area by generating heat in the heating element from current applied to the heating element;
placing a repair patch over the heating element after adhering the heating element to the repair area; and
applying a current to the heating element to heat the repair patch to a patch processing temperature.

2. The method of claim 1 further comprising:
applying compression to the repair patch while heating the repair patch to the patch processing temperature to join the repair patch to the thermoplastic composite part.

3. The method of claim 1 further comprising:
removing a portion of the thermoplastic composite part to form the repair area.

4. The method of claim 1, wherein the repair patch comprises a thermoplastic repair patch.

5. The method of claim 4, wherein the patch processing temperature is approximately 280° C.-340° C.

6. The method of claim 5 further comprising:
applying pressure of approximately 15 psi-45 psi to the repair patch while heating the repair patch to join the repair patch to the thermoplastic composite part.

7. The method of claim 6 further comprising:
removing the pressure from the repair patch after allowing the repair patch to cool to 150° C.

8. The method of claim 1, wherein the repair patch comprises a thermoset repair patch.

9. The method of claim 8, wherein the patch processing temperature is approximately 170° C.-190° C.

10. The method of claim 9 further comprising:
applying pressure of approximately 60 psi-90 psi to the repair patch while heating the repair patch to join the repair patch to the thermoplastic composite part.

11. The method of claim 10 further comprising:
removing the pressure from the repair patch after allowing the repair patch to cool to ambient temperature.

12. The method of claim 1 further comprising:
trimming ends of the heating element extending from the thermoplastic composite part.

13. The method of claim 1 further comprising:
treating a surface of the repair area prior to applying the heating element, wherein treating comprises cleaning and sanding the repair area.

14. A method of repairing a thermoplastic composite part comprising:
placing a heating element impregnated with a thermoplastic material onto a repair area of a thermoplastic composite part;
adhering the thermoplastic material of the heating element to the repair area by generating heat in the heating element from current applied to the heating element;
placing a thermoplastic repair patch over the heating element after adhering the heating element to the repair area;
heating the thermoplastic repair patch to a patch processing temperature using the heating element; and
applying pressure to the thermoplastic repair patch while heating the thermoplastic repair patch.

15. The method of claim 14, wherein the patch processing temperature is 280° C.-340° C.

16. The method of claim 14, wherein the pressure is 15 psi-45 psi.

17.-18. (canceled)

19. The method of claim 14 further comprising:
trimming ends of the heating element extending from the thermoplastic composite part.

20. A method of repairing a thermoplastic composite part comprising:
placing a heating element impregnated with a thermoplastic material onto a repair area of a thermoplastic composite part;
adhering the thermoplastic material of the heating element to the repair area by generating heat in the heating element from current applied to the heating element;
placing a thermoset repair patch over the heating element after adhering the heating element to the repair area;
heating the thermoset repair patch to a patch processing temperature using the heating element; and
applying pressure to the thermoset repair patch while heating the thermoset repair patch.

21. The method of claim 20, wherein the patch processing temperature is approximately 170° C.-190° C.

22. The method of claim 20 further comprising:
applying pressure of approximately 60 psi-90 psi to the thermoset repair patch while heating the thermoset repair patch to join the thermoset repair patch to the thermoplastic composite part.

23. The method of claim 22 further comprising:
removing the pressure from the thermoset repair patch after allowing the thermoset repair patch to cool to ambient temperature.

24.-25. (canceled)

26. A method of repairing a thermoplastic composite part comprising:
adhering a low melt thermoplastic material of a heating element to a repair area of a thermoplastic composite part; and
adhering the low melt thermoplastic material to a repair patch.

27. The method of claim 26 further comprising:
applying compression to the repair patch while heating the repair patch to a patch processing temperature to join the repair patch to the thermoplastic composite part.

28.-31. (canceled)

32. The method of claim 26, wherein adhering the low melt thermoplastic material to the repair area comprises heating the heating element by applying a current to the heating element.

33. The method of claim 26, wherein adhering the low melt thermoplastic material to the repair patch comprises heating the heating element by applying a current to the heating element.
